(19) United States
(12) Patent Application Publication
(10) Pub. No.: US 2018/0319290 A1
(43) Pub. Date: Nov. 8, 2018

(54) DEVICE FOR TEMPERATURE CONTROL OF CERTAIN AREAS AND FOR RECOGNIZING OCCUPATION THEREOF BY PERSONS AND/OR OBJECTS, AND SEATING AND/OR RECLINING APPARATUS INCLUDING SUCH A DEVICE

(71) Applicant: GENTHERM GMBH, Odelzhausen (DE)

(72) Inventors: Björn Wawrok, Augsburg (DE); Sandra Schicho, München (DE)

(21) Appl. No.: 15/770,033

(22) PCT Filed: Oct. 25, 2016
(86) PCT No.: PCT/DE2016/000381

§ 371 Date: Apr. 20, 2018

(30) Foreign Application Priority Data
Oct. 30, 2015 (DE) 10 2015 014 014.0

(51) Int. Cl. B60N 2/00; B60N 2/56; B60R 21/015; H05B 3/56

(52) U.S. Cl. CPC B60N 2/002; B60N 2/5685; H05B 2203/029; H05B 3/56; B60R 21/01532

(57) ABSTRACT

A device (1) for temperature control and for recognizing an occupation of certain areas by a person and/or an object are disclosed. The device includes at least one electrically conductive heating line (23) that is designed for releasing heat energy, and at least one electrode (3, 5) adjoining the at least one electrically conductive heating line (23), the longitudinal axis of the electrode extending, at least in sections, along the at least one heating line. The at least one electrode (3, 5) is mechanically coupled to the at least one heating line (23), and is designed as a component of a capacitive sensor system, by means of which a presence of persons and/or objects within a certain area is determinable.

The present invention relates to a device for temperature control of certain areas and for recognizing occupation thereof by persons and/or objects.

Vehicle seats in particular are increasingly being equipped with seat heating devices for enhancing the traveling comfort for vehicle occupants. In these types of seat heating devices, a heating panel which can release heat to the seating surface of the vehicle seat as needed is spanned by heating elements, such as heating litz wires or other temperature-controllable elements, in the seat or seat back area of the vehicle seat.

Independently of the heating elements, one or more sensors may be provided which recognize an occupation of the seat. The one or more sensors may, for example, be integrated into a seating surface. The seat occupancy may then be utilized to activate and deactivate the heating elements. Vehicles are also known in which the seat occupancy recognition is used for other functions in the motor vehicle. For example, an acoustic signal may be output when a seat occupancy is recognized and a seat belt is not, or is not properly, fastened.

For some time, these heating elements of the seat heating, already in use, have at the same time been utilized for detecting the occupation of the particular vehicle seat by sensor. This is advantageous since, due to the fact that installation of dedicated capacitive sensors is not necessary, such vehicle seats may have an uncomplicated, simple, and cost-effective design.

Such a vehicle seat is known from DE 10 2009 016 965 A1, in which heating elements or heating wires are used for detecting a seat occupancy by sensor. The heating wire, via which the vehicle seat may be heated, in a first operating state is used for controlling the temperature of the vehicle seat, and in a second operating state is used as an electrode for determining a seat occupancy.

The heating wires, as also described by the cited German patent application, are made of metallic materials. During intensive use of the seat, the heating elements are subjected to continuous load and therefore experience high mechanical stress. On account of their material design, the heating elements are not durable, and may break or suffer damage due to material fatigue, resulting in functional failure of the heating elements. If the heating elements according to the prior art are also used as a sensor for seat occupancy, this function may also be impaired. In the devices known from the prior art, a failure of the seat heating is thus accompanied by a malfunction of the seat occupancy recognition.

The object of the invention, therefore, is to provide a corresponding device and a seating and/or reclining apparatus that are less likely to experience malfunction of the occupancy recognition, compared to the prior art. It is also the aim that the device and the seating and/or reclining apparatus have an uncomplicated design and are cost-effective to manufacture.

The above object is achieved by a device and a seating and/or reclining apparatus comprising the features in Patent Claims 1 and 13. Further advantageous embodiments are described by the subclaims.

The invention relates to a device for temperature control of certain areas and for recognizing occupancy thereof by persons and/or objects. The certain area in question may be provided on a vehicle seat, for example. The vehicle seat may be designed as a component of a passenger vehicle or aircraft. However, the invention is not limited to these types of vehicle seats. Thus, the area may be provided, for example, on reclining furniture, and in particular on a patient bed. If a patient undesirably or inadvertently leaves the patient bed, this undesirable or inadvertent action may be detected by means of the occupancy recognition described in greater detail below.

In further embodiments it is conceivable for the certain area to be provided in the region of a shoe sole in which at least one heating line, described in greater detail below, is situated in order to selectively control the temperature of the shoe sole as a function of an occupancy recognition. If a shoe having the shoe sole in question is worn by a person, this may be detected by means of the occupancy recognition, as the result of which the at least one heating line is automatically actuated for controlling the temperature of the shoe sole. The device may also be used for other items of clothing, wherein temperature control of the particular item of clothing may be initiated, with consideration for an occupancy recognition or use of the item of clothing in question.

In practice, embodiments may also be provided in which the device is used as a component of a floor mat of a motor vehicle. If a person in the motor vehicle, i.e., an occupation, is recognized via the device designed as a component of the floor mat, temperature control of the floor mat may be initiated.

As mentioned above, the device includes at least one electrically conductive heating line that is designed for releasing heat energy. In preferred embodiments, the heating line may be designed as a heating wire. It is conceivable for the at least one heating line or heating wire to be laid out in a meandering manner in a seating and/or reclining apparatus or in the particular apparatus in which the device is used.

In addition, the device includes at least one electrode adjoining the at least one electrically conductive heating line, the longitudinal axis of the electrode extending, at least in sections, along the at least one heating line. The at least one heating line and the at least one electrode may extend at least approximately parallel to one another. In conceivable embodiments, the at least one electrically conductive heating line and the at least one electrode adjoining the at least one electrically conductive heating line may be in surface contact with one another.

Furthermore, the at least one electrode is mechanically coupled to the at least one heating line. For example, the mechanical coupling may be designed in such a way that no, or essentially no, relative movement can take place between the at least one heating line and the at least one electrode. For this purpose, the at least one electrode, as mentioned below, may accommodate the at least one heating line, at least in sections, or may be completely guided around the at least one heating line. In addition, for mechanically coupling the at least one electrode to the at least one heating line, a jacket may be provided which accommodates the at least one electrode and the at least one heating line.

If several or a plurality of heating lines are provided, the at least one electrode may be guided around the several or plurality of heating lines. The at least one electrode may therefore be designed as a jacket or as a component of a jacket which accommodates the at least one electrode. It may also be provided that the jacket includes an exterior extrusion that is designed as a nonconductor, and an interior extrusion that is designed as an electrode and optionally made of electrically conductive plastic. In other conceivable embodiments, the jacket may be designed solely, i.e., throughout, as a nonconductor, and may optionally be made of plastic. The at least one electrically conductive heating line may be accommodated by the jacket with or without play. The jacket may be made entirely or partially of plastic. The exterior extrusion may be made of electrically nonconductive plastic. In addition, the interior extrusion may be made of electrically conductive plastic.

The at least one electrode is also designed as a component of a capacitive sensor system by means of which a presence of persons and/or objects within a certain area is determinable. The capacitive sensor system may be designed, for example, as a pressure sensor, distance sensor, proximity sensor, and/or some other capacitive sensor. Accordingly, the device may include a counter electrode that cooperates with the at least one electrode in order to determine a presence of persons and/or objects within the certain area.

Since according to the invention, in addition to the at least one heating line an electrode, independent of the heating line, for determining a presence of objects and/or persons is provided, occupancy recognition may also reliably take place if the at least one heating line is broken or defective. A compact, robust device for temperature control and occupancy recognition of areas or certain regions is provided due to the mechanical coupling and the arrangement according to the invention of the at least one electrode along the at least one heating line.

Embodiments have proven suitable in particular in which the at least one electrode has a lower electrical conductivity than the at least one heating line. For example, the at least one heating line may have an electrical resistance of up to 100 D/m and in particular up to 10 D/m. The at least one heating line may have a maximum cross-sectional diameter that is designed to be less than 200 μm or that does not exceed 200 μm.

The device may be designed as a heating litz wire or may include a heating litz wire. As mentioned above, the at least one heating line and the at least one electrode may extend within a jacket of the device or heating litz wire designed as a nonconductor. The jacket, the at least one heating line, and/or the at least one electrode may have an at least approximately circular cross section.

In addition, the at least one heating line may be made of metal. In preferred embodiments, the at least one heating line may be made of copper or a copper alloy. In practice, embodiments have proven suitable in which the at least one heating line is made of copper, copper-tin, copper-zinc, and/or copper-nickel.

Moreover, the device or heating litz wire may include a plurality of heating lines, the plurality of heating lines being positioned in a circle around a strain relief element. The strain relief element may be situated within the jacket described above. The strain relief element may have a flexible design and may optionally be made of plastic. It is also conceivable for the strain relief element to be designed as an electrode that is mechanically coupled to the at least one heating line, the longitudinal axis of the electrode extending, at least in sections, along the at least one heating line. A presence of persons and/or objects within the certain area may thus be determined with the assistance of the electrode designed as a strain relief element. The strain relief element and the above-described jacket, optionally designed as a nonconductor, may extend in parallel and optionally concentrically with respect to one another. The strain relief element may thus have a circular cross section.

Furthermore, the at least one electrode or the strain relief element may be made of an electrically conductive plastic. It is also conceivable for an electrically conductive layer to be applied to the at least one electrode or to the strain relief element, and for the strain relief element to be made of a nonconductor. The electrically conductive layer may, for example, be formed by a coating and/or a plating. The at least one electrode or the strain relief element may also be elastically deformable in order to have little or no signs of fatigue, even under high mechanical stress.

In further embodiments the device may include a control unit,
the control unit being connected to the at least one electrode, so that with the assistance of the at least one electrode, information concerning the presence of persons and/or objects within the certain area is transmittable to the control unit, and
the control unit being coupled to the at least one heating line in such a way that
the control unit may selectively bring about or prevent the release of heat energy via the at least one heating line, taking the information into account.

If a presence of persons and/or objects within the certain area is determined with the assistance of the at least one electrode or the capacitive sensor system, the control unit may bring about a release of heat energy via the at least one heating line. If a presence of persons and/or objects within the certain area is not determined with the assistance of the at least one electrode or the capacitive sensor system, the control unit may prevent a release of heat energy via the at least one heating line.

In addition, the device may include at least one work instrument, such as an airbag or the like, that is coupled to the control unit, the work instrument being selectively activatable or deactivatable via the control unit, taking the information or the occupancy recognition into account.

In conceivable embodiments, the device may also include at least one display unit that is connected to the control unit, and via which the information concerning the presence of persons and/or objects within the certain area is visually displayable. The display unit may be designed as a display, for example. By means of the display unit, a user may be informed, if necessary, about a release of heat energy via the at least one heating line.

The invention further relates to a seating and/or reclining apparatus that includes a device described above. In the seating and/or reclining apparatus according to the invention, the at least one electrode and the at least one electrically conductive heating line are positioned or embedded in a cushion structure of the seating and/or reclining apparatus. In addition, the capacitive sensor system has a counter electrode, preferably positioned beneath the electrode, which is brought into operative connection with the at least one electrode in order to determine the presence of persons and/or objects on the seating and/or reclining apparatus.

Exemplary embodiments of the invention and their advantages are explained in greater detail below with reference to the appended figures. The proportions of the individual elements with respect to one another in the figures do not always correspond to the actual proportions, since some shapes are simplified, and other shapes are illustrated in enlarged form in relation to other elements for better clarity.

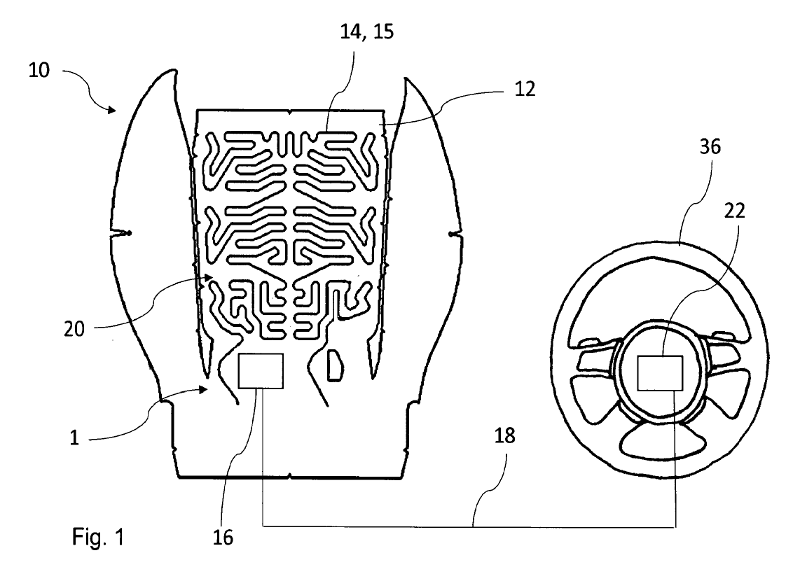

FIG. 1 shows a schematic view of one embodiment of a seating apparatus according to the invention, together with one embodiment of a device according to the invention;

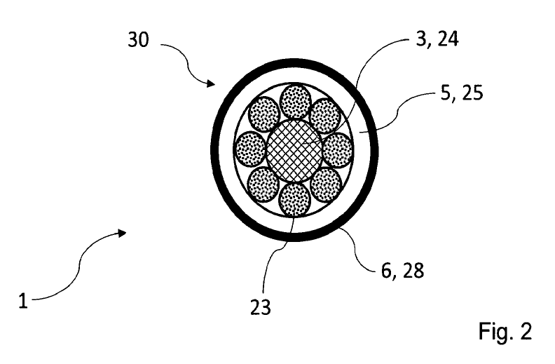

FIG. 2 shows a schematic cross section of one embodiment of a device according to the invention; and

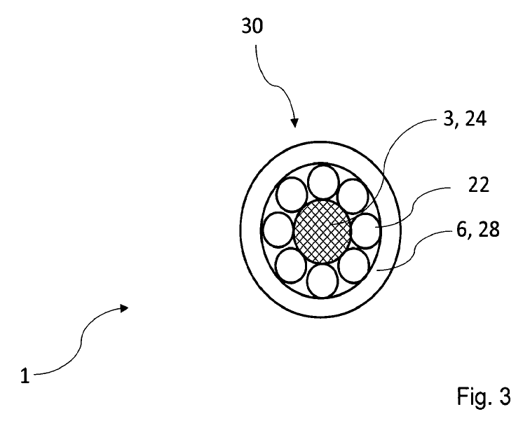

FIG. 3 shows a schematic cross section of another embodiment of a device according to the invention.

Identical reference numerals are used for similar or functionally equivalent elements of the invention. In addition, for the sake of clarity, only reference numerals that are necessary for describing the particular figure are illustrated in the individual figures. The illustrated embodiments merely represent examples of how the invention may be configured, and do not constitute a definitive limitation.

FIG. 1 shows a schematic view of one embodiment of a seating apparatus 10 according to the invention, together with one embodiment of a device 1 according to the invention. The device 1 is designed for controlling the temperature of the seating apparatus 10 and for recognizing occupation thereof by persons and/or objects.

The device 1 includes a heating element 14 that is embedded in a meandering manner in a seating surface 12 of the seating apparatus 10. Conceivable embodiments for the heating element 14, which is designed as a heating litz wire 15, are shown in FIGS. 2 through 4, in each case in cross section. The temperature of the seating apparatus 10 may be controlled via the heating element 14. In addition, an occupation of the seating apparatus 10 may be recognized via or with the assistance of the heating element 14.

For this purpose, the heating element 14 or the heating litz wire 15 is connected to a control unit, as illustrated in FIG. 1 with reference to reference numeral 16. A user may specify a certain desired power for the heating element 14 via the control unit 16.

The heating element 14, as described in greater detail below with reference to FIGS. 2 and 3, includes at least one electrode 3 or 5, which is designed as a component of a capacitive sensor system; the control unit 16 may determine an occupation of the seating apparatus 10 with the assistance of the at least one electrode 3 or 5. Since the heating element 14 together with its at least one electrode 3 or 5 is positioned in the seating surface 12, the occupancy recognition takes place over the certain area 20 that is present in the surroundings of the seating surface 12. The heating element 14 is covered by a cushion structure and a seat cover, not illustrated in FIG. 1 of the present patent application. The at least one electrode 3 or 5 cooperates with a counter electrode, not illustrated, in order to determine the presence of persons and/or objects on the seating apparatus 10. The at least one electrode 3 or 5 and the counter electrode are components of a capacitive sensor system.

The control unit 16 is also able to distinguish between an occupation by an object and an occupation by a person, as a function of a signal that is received via the capacitive sensor system. Taking into account an occupation of the seating apparatus 10 by an object or by a person, the control unit 16 may then control the heating element 14 to release heat energy, or to prevent a release of heat energy by the heating element 14. If, for example, a pocket is placed in the certain area 20, the control unit 16 may prevent a release of heat energy by the heating element 14, whereas a release of heat energy by the heating element 14 may be initiated via the control unit 16 if the at least one electrode 3 or 5, designed as a component of the heating element 14 or of the device 1, determines a presence of a person in the certain area 20.

An airbag system 20 [sic; 22] which automatically opens in the event of a collision of a passenger vehicle, having the vehicle seat 10 and a steering wheel 36, is integrated into the steering wheel 36. If the control unit 16 does not determine an occupation of the seating apparatus 10, i.e., an occupation by a person, in the certain area 20, the control unit 16 prevents the airbag system 20 [sic; 22] from opening in the event of a collision of the motor vehicle, not illustrated in the present patent application. However, if the control unit 16 determines an occupation of the seating apparatus 10, i.e., an occupation by a person, in the certain area 20, the control unit 16 allows the airbag system 20 [sic; 22] to open in the event of a collision of the motor vehicle, not illustrated in the present patent application.

Furthermore, a plurality of such vehicle seats 10, each with the device 1, may be used as passenger seats in an aircraft. The control units 16 of the respective devices 1 may be connected to a shared controller which outputs and/or displays information concerning occupied passenger seats and unoccupied passenger seats, optionally in real time. In addition, only one shared control unit may be provided, which is connected to all devices 1 or heating elements 14 which are designed for occupancy recognition and temperature control of the passenger seats, and which outputs and/or displays information concerning occupied passenger seats and unoccupied passenger seats. If an occupation of all passenger seats during flight operation is necessary for safety reasons, the occupation in question may be determined with the assistance of the device 1.

FIG. 2 shows a schematic cross section of one embodiment of a device 1 according to the invention. A control unit 16 is not illustrated in FIG. 2, but may be provided as a component for a device 1 according to FIG. 2.

The device 1 includes multiple electrically conductive heating lines 23, each having a circular cross section and being made of a copper alloy. A strain relief element 24 which likewise has a circular cross section is positioned between the heating lines 23. The heating lines 23 are positioned in a circle around the strain relief element 24, i.e., about the longitudinal axis of the strain relief element 24. If temperature control is desired, a release of heat energy via the heating lines 23 may be initiated by means of the control unit 16 (see FIG. 1).

The strain relief element 24 is made of a plastic that is at least slightly electrically conductive. Voltage may thus be applied to the strain relief element 24, wherein the strain relief element 24, as an electrode 3, cooperates with a counter electrode, not illustrated in FIG. 2, as a capacitive sensor in order to recognize a presence of persons or objects in a certain area 20, which may be provided in the surroundings of a seating surface 12, for example. Voltage may be applied to the heating lines 23 and the strain relief element 24, designed as an electrode 3, via a shared crimp.

The strain relief element 24, designed as an electrode, and the heating lines 23 are accommodated in a form-fit manner by a jacket 30 that is made up of an interior extrusion 25 and an exterior extrusion 28. The interior extrusion 25 has at least slight electrical conductivity, and is made of plastic. When a voltage is applied to the interior extrusion 25, the interior extrusion 25, as an electrode 5, may cooperate with a counter electrode, not illustrated in FIG. 2, as a capacitive sensor in order to recognize a presence of persons or objects in a certain area 20, which may be provided in the surroundings of a seating surface 12, for example.

The exterior extrusion of the jacket 30 is designed as a nonconductor 6 and thus has no, or essentially no, electrical conductivity. Unintentional contact with the heating lines 23 or the interior extrusion 25 is counteracted via the exterior extrusion 6 or via the jacket 30.

The heating lines 23 and the strain relief element 24 may be accommodated by the jacket 30 in a form-fit manner or with little play. If one or more of the heating lines 23 are damaged by mechanical stress, the occupancy recognition may be maintained by means of one or both of the electrodes 3 or 5.

FIG. 3 shows a schematic cross section of another embodiment of a device 1 according to the invention. The device 1 according to FIG. 3 also has a strain relief element 24, which is designed as an electrode 3 and made of electrically conductive plastic, and which acts [sic; cooperates] with a counter electrode as a capacitive sensor. The strain relief element 24 as well as the heating lines 23 are completely enclosed by a jacket 30 designed as a nonconductor 6. The electrical conductivity of the heating wires 23 is designed to be greater than the electrical conductivity of the strain relief element 24. The heating wires 23 are also made of copper or a copper alloy, while the jacket 30 and the strain relief element 24, designed as an electrode 3, are made of plastic. The heating wires 23 are mechanically coupled to the strain relief element 24 via the jacket 30.

The invention has been described with reference to one preferred embodiment. However, it is conceivable for those skilled in the art to make use of modifications or changes to the invention without departing from the scope of protection of the claims set forth below.

### LIST OF REFERENCE NUMERALS

1 device

3 electrode

5 electrode

6 nonconductor

10 seating apparatus

12 seating surface

14 heating element

15 heating litz wire

16 control unit

18 connection

20 certain area

22 airbag system

23 heating line

24 strain relief element

25 first extrusion

28 second extrusion

30 jacket

36 steering wheel

1. A device comprising
at least one electrically conductive heating line that is designed for releasing heat energy, and
at least one electrode adjoining the at least one electrically conductive heating line a longitudinal axis of the at least one electrode extending, at least in sections, along the at least one electrically conductive heating line,
wherein the at least one electrode is mechanically coupled to the at least one electrically conductive heating line, and is designed as a component of a capacitive sensor system by means of which a presence of persons and/or objects within a certain area is determinable so that the device controls temperature of the certain areas and recognizes occupation thereof by persons, objects, or both.

2. The device according to claim 1, wherein the at least one electrode has a lower electrical conductivity than the at least one electrically conductive heating line.

3. The device according to claim 1, wherein the at least one electrical conductive heating line is made of metal.

4. The device according to claim 3, wherein the at least one electrically conductive heating line is made of copper or a copper alloy.

5. The device according to claim 1, wherein the at least one electrically conductive heating line is a plurality of heating lines and a flexible strain relief element, the plurality of heating lines being positioned in a circle around the flexible strain relief element.

6. The device according to claim 5, wherein the flexible strain relief element is an electrode.

7. The device according to claim 1, wherein the at least one electrode made of an electrically conductive plastic, and/or an electrically conductive layer is applied to the at least one electrode.

8. The device according to claim 1, wherein the at least one electrode is designed as a jacket or a component of the jacket, within which the at least one electrically conductive heating line is accommodated.

9. The device according to claim 8, wherein the jacket includes an exterior extrusion that is designed as a nonconductor, and includes an interior extrusion that is designed as the at least one electrode.

10. The device according to claim 1, comprising a control unit,
the control unit being connected to the at least one electrode, so that with the assistance of the at least one electrode, information concerning the presence of persons and/or objects within the certain area is transmittable to the control unit, and
the control unit being coupled to the at least one electrically conductive heating line such a way that
the control unit selectively controlling a release of heat energy or preventing the release of heat via the at least one heating line, taking the information into account.

11. The device according to claim 1, comprising at least one work instrument that is coupled to a control unit, the work instrument being selectively activatable or deactivatable via the control unit, taking information into account.

12. The device according to claim 10, comprising at least one display unit that is connected to the control unit, and via which the information concerning the presence of persons and/or objects within the certain area is visually displayable.

13. A seating and/or reclining apparatus, comprising a device according to claim, wherein
the at least one electrode and the at least one electrically conductive heating line are positioned in a cushion structure of the seating and/or reclining apparatus; and
the capacitive sensor system has a counter electrode, that is positioned beneath the at least one electrode, which is brought into operative connection with the at least one electrode in order to determine the presence of persons and/or objects on the seating and/or reclining apparatus.
